(19) United States
(12) Patent Application Publication
(10) Pub. No.: US 2007/0124026 A1
(43) Pub. Date: May 31, 2007

(54) Agent Based Auction System and Method for Allocating Distributed Energy Resources

(75) Inventors: Wade Troxell, Carlsbad, CA (US); Gerald Gibson, Carlsbad, CA (US)

Correspondence Address: PROCOPIO, CORY, HARGREAVES & SAVITCH LLP, 530 B STREET, SUITE 2100, SAN DIEGO, CA, 92101, US

(73) Assignee: ALTERNATIVE ENERGY SYSTEMS CONSULTING, INC., Carlsbad, CA (US)

(21) Appl. No.: 11/565,380

(22) Filed: Nov. 30, 2006

Related U.S. Application Data
(60) Provisional application No. 60/741,353, filed on Nov. 30, 2005.

(51) Int. Cl. G05D 11/00

(52) U.S. Cl. 700/291; 700/295

(57) ABSTRACT

The present invention is directed to a power-grid infrastructure for energy as well as methods for efficiently distributing the energy within the infrastructure that rely on a decentralized approach and the use of intelligent agents to facilitate the communication between different levels of the infrastructure as well as the distribution of the energy across the actual electrical couplings within the infrastructure.

### CROSS REFERENCE TO RELATED APPLICATIONS

This application claims priority to U.S. Provisional Patent Application No. 60/741,353, filed Nov. 30, 2005, and entitled “AGENT BASED AUCTION SYSTEM AND METHOD FOR ALLOCATING DISTRIBUTED ENERGY RESOURCES”, which is hereby incorporated herein by reference.

### FIELD OF THE INVENTION

The present invention relates generally to the allocation of distributed energy resources.

### BACKGROUND

The electric grid is a physical infrastructure that supplies power to individuals in their homes and businesses and has become an essential part of modern life. Lighting, climate control, computers, appliances, and everything else that runs on electrical power require an electric grid that is operating properly. At the same time the electric grid needs to allocate the available energy properly so that certain geographical areas do not run out of energy and so that certain areas do not have a large amount of excess, unused energy.

The existing electric grid control infrastructure is based on a paradigm wherein individual electric utilities centrally control virtually all grid functions within their service territory. The existing system includes centrally located generation with power dispatched to various regions via transmission and distribution systems that are also centrally controlled. Safety systems located within the transmission and distribution systems are either centrally controlled or operate individually with actions that are essentially pre-defined. The complexity of the grid control problem is compounded by the fact that electricity cannot be effectively stored in the system thus requiring that the supply and load be perfectly matched at all times.

The reliability and security of the U.S. electric grid is a major concern. Currently, research and development efforts are divided between two basic areas. In a first basic area, utility companies are focused on upgrading and strengthening the existing centrally controlled infrastructure. In a second basic area, advancement involves integrating advanced information technologies in the grid infrastructure that would fully integrate site energy related activities with grid activities. This integration would occur via a transaction based control system where sites (and even individual appliances) respond to dynamic pricing or other signals.

The first approach has the advantage of being easier to integrate into the existing electric grid, since the existing electric grid already functions on a central control paradigm. The first approach, however, is not able to take advantage of distributed energy resources (“DER”). DER, when integrated properly with the electric grid, can provide both economic and societal benefits. Economic benefits occur in the form of reduced energy costs for end users. Societal benefits occur in the form of achieving a more robust electric grid, which is less vulnerable to a terrorist attack or other disruption. For DER benefits to be fully realized, however, it is necessary that their operation be fully integrated with other grid control and safety systems; systems that must respond rapidly to locally changing conditions. Thus, for DER benefits to be fully realized a centralized approach to controlling the electric grid will not work. As such, the first approach has the shortcoming of not being able to take advantage of the DER paradigm.

The second approach relies on a decentralized/distributed control paradigm that depends heavily on distributed generation and local load control. One attempt to apply DER to the electric grid relies on a “self-healing grid” concept. The self-healing grid concept relies on developing an open communications architecture that will facilitate the use of distributed generation and storage technologies in the grid. The objectives of the project include development of standardized communication object models that will facilitate the application of DER in the grid as well as enable flexible reconfiguration of distribution systems into islands when needed.

Regarding operation of the network, the self-healing grid uses local controllers that would collaborate to form islands of independent operation during grid disturbances and would collaborate with higher-levels to facilitate reconnection to the grid. The self-healing grid concept, however, currently provides little details and is still under development.

Another attempt to use the second, decentralized, approach to the electric grid, called the “Grid of the Future” concept, emphasizes the use of DER within “local microgrids”. A microgrid is a grouping of generating sources and end use loads that operate in a semi-autonomous fashion for the benefit of the microgrid participants. The micro-grid includes distributed resources capable of serving one or more customers independent from the grid either full-time or in the event of a grid power failure.

The generating sources may include microturbines, fuel cells, photovoltaic systems, and storage devices, all of which are interconnected through power electronic devices. A critical microgrid feature is that it appears to the distribution system to be a single customer.

The microgrid is designed to deal with issues concerning control of the point of common coupling (“PCC”), energy management within the microgrid, and protection coordination within the microgrid. The DER assets are essentially enclosed in a microgrid “shell” that insulates the grid from the DER and vice versa. The microgrid concept allows the existing protection systems to remain intact and issues associated with islanding, reconnection, etc. are handled internally within the microgrid. The microgrid concept, however, is not fully decentralized and it is still in its infancy as a technological concept.

Another attempt to use the second, decentralized, approach to the electric grid emphasizes integration of the traditional elements of supply and demand, transmission, and distribution with new technologies such as distributed generation, energy storage, and customer load management, using information to make them function as a complex, integrated system. The emphasis is on market response in the form of residential, appliance level reaction to either pricing signals or upon detection of system upset. This approach is moving toward an energy system that is controlled by a distributed network with the ability to dynamically reconfigure the system as needed in response to man-made and natural disasters. This approach optimizes energy resources by allowing all elements of the energy system to work together and adapt to changes in environmental conditions.

Some problems with the first, centralized approach to the power grid are that it is vulnerable to attack, non-responsive to local needs, and unable to take advantage of the benefits of DER. Some problems with the second, decentralized approaches include immature technologies and that solutions are far from being implemented in the existing electric grid. Therefore, the complexity of the many problems associated with the decentralized approach are not fully solved.

### SUMMARY

The present invention is directed to a power-grid infrastructure for energy as well as methods for efficiently distributing the energy within the infrastructure that rely on a decentralized approach and the use of intelligent agents to facilitate the communication between different levels of the infrastructure, for the acquisition of the energy, as well as the distribution of the energy across the actual transmission lines (i.e., electrical couplings) within the infrastructure.

In one embodiment, the infrastructure comprises a hierarchical arrangement of an electric grid. At the distribution level, the hierarchical arrangement includes one or more power neighborhoods. Each of the power neighborhoods includes site manager agents each of which represent the interests of a site located within the power neighborhood. A plurality of the site manager agents communicatively coupled as well as electrically coupled to one another comprises a power neighborhood.

The communicative coupling includes a means for sending messages for control and certain actions by the agents to one another and to different levels in the hierarchy. The electrical coupling includes the actual physical connections and or devices implemented in the electric grid that are used to transfer electricity and/or power between the different levels in the hierarchy. The power neighborhood may be thought of as the lowest unit in the hierarchy or it can be further subdivided into buildings or individual collections of buildings, for example.

One or more of the distribution substations are provided at the level of the hierarchy above the power neighborhood. The distribution substations include a distribution substation agent, which is communicatively coupled and electrically coupled to all of the power neighborhoods that lie within its control area. One or more utility levels are provided at the next level of the hierarchy, each of the utility levels includes a utility level agent and having a communicative coupling and an electrical coupling to all of the distribution substations that lie within its control area. One or more independent system operator (“ISO”) levels are provided at the next level of the hierarchy, each of the ISO levels including an ISO level agent and having a communicative coupling and an electrical coupling to all of the utility levels that lie within its control area.

Within the infrastructure various auction methods are implemented to facilitate the exchange of energy through the electrical couplings in the hierarchy with the assistance of the agents at each level. In one embodiment, the auction process is a Dutch auction that occurs at the power neighborhood level, wherein the energy is offered, for example, by the distribution substation to one of the power neighborhoods through which it has an electrical coupling. The auction process can be network based, for example, and the agents themselves may be the participants. As participants the agents may post auction sessions for the sale or purchase of energy or may bid independently and autonomously into the auction sessions posted by other participants. Auction sessions and/or bids are developed by agents for the energy based on the various states that may occur, including site specific energy needs, local DER asset capabilities, any disruptions that may have occurred to the power-grid, and the price of the energy that is currently available from the grid via the distribution substation agent.

For example, the auction may start at a certain specified price and then the price is reduced over time until one of the agents determines that it is in the interest of its site, neighborhood, or area of control to buy the energy at that price. The entity offering the auction may withdraw it at any time if no agent bids for the energy.

Various command signals are propagated throughout the hierarchy both from the lower levels to the higher levels and vice-versa along the communicative couplings. For example, higher levels may send pricing signals to the lower levels which may cause the agent to participate in an auction if the agent determines the price is appropriate for what it needs. Similarly, the lower level, in the case of a disruption or an excess load, may send signals to a higher level to repair the disruption or to offer its excess capacity via the auction process to other agents of the same level who do not have excess capacity.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an example hierarchical structure for a power-grid infrastructure according to an embodiment of the present invention.

FIG. 2 is a block diagram illustrating an example electrical coupling according to an embodiment of the present invention.

FIG. 3 is a block diagram illustrating an example communicative coupling according to an embodiment of the present invention.

FIG. 4 is a diagram illustrating an example process for conducting an energy auction according to an embodiment of the present invention.

FIG. 5 is a diagram illustrating an example process for conducting an energy auction according to an embodiment of the present invention.

FIG. 6 is a diagram illustrating an example process for agent participation in an auction according to an embodiment of the present invention.

FIG. 7 is a block diagram illustrating an example intra-neighborhood transmission disruption according to an embodiment of the present invention.

FIG. 8 is a diagram illustrating an example process for handling a grid disturbance according to an embodiment of the present invention.

FIG. 9 is a block diagram illustrating an example supply disruption at the utility level according to an embodiment of the present invention.

FIG. 10 is a block diagram illustrating an example computer system that may be used in connection with various embodiments described herein.

### DETAILED DESCRIPTION

Certain embodiments as disclosed herein provide for a power-grid infrastructure for energy as well as methods for efficiently distributing the energy within the infrastructure that rely on a decentralized approach and the use of intelligent agents to facilitate the communication between different levels of the infrastructure as well as the distribution of the energy across the actual electrical couplings within the infrastructure. As used herein, the term “level” is synonymous with the term “station” so that the term “utility level”, for example, has the same meaning as “utility station”.

One method, for example, as disclosed herein allows for an auction process, which may be network based and the agents themselves may be the participants. As participants, the agents may post auction sessions for the sale or purchase of energy or may bid independently and autonomously into the auction sessions posted by other participants. Auction sessions and/or bids are developed by agents for the energy based on the various states that may occur, including site specific energy needs, local DER asset capabilities, the state of the infrastructure (i.e., any disruptions in the infrastructure that may have occurred), and the price of the energy that is currently available from the grid via the distribution substation agent. For example, the auction session may start at a certain specified price and then the price is reduced over time until one of the agents determines that it is in the interest of its neighborhood or area of control to buy the energy at that price. The entity auctioning the energy may withdraw it at any time if no agent bids for the energy.

As used herein the “agent” generally coordinates the actions of an individual or multiple sites with multiple DER assets in response to a communicative coupling that includes dynamic price signals. These same agents are also able to quickly reallocate DER resources within an electrical coupling (i.e., the various physical devices implemented in the electrical grid that are able to cause the electricity to travel from point A to point B), in response to a signal indicating the eminent loss of all or part of the grid supplied power.

At its most basic level, an “agent” is simply an entity that acts on behalf of its user. More specifically, a “software agent” is a software module that can act on behalf of the user. For purposes of the present invention an intelligent software agent executes autonomously & operates in real-time; communicates with other agents or users; is able to exploit domain knowledge; and exhibits goal-oriented behavior. As used herein, the term “agent” is used interchangeably with the terms “intelligent software agent,” “software agent,” and “intelligent agent”.

As used herein the term “DER” represents a broad-based collection of devices that can be characterized as energy and power producing, consuming, storage, controls, monitoring, or conditioning devices. Each of these components of DER may be information-level devices that are able to be networked in concert together utilizing a variety of protocols and open architectures allowing for interoperability between devices.

The kinds of equipment found on a local level may be energy and power generating equipment located in relative proximity to the consumption or load such as: turbines and microturbines; internal combustion generators; batteries; fuel cells; wind turbines; solar generators (“photo-voltaic cells”); and combined heat and power packages. Consumption devices affected by an outage are considered to be the load. Typical commercial and industrial loads can be localized in manufacturing and process equipment such as: motors; boilers; pumps; compressors; elevators, chillers, and lighting. Storage devices may include: rotational inertial mass or flywheels; uninterruptible power supplies (“UPS”); and batteries. Control devices may include: building control systems (“BCS”); switchgear; device embedded controllers; and remote terminal units (“RTUs”) and gateways. Monitoring devices are configured for measurement and metering to account for the utilization of the power. Monitoring devices typically monitor or measure power and electricity consumption (or generation) includes such equipment as: revenue grade meters; current transformers; and data loggers.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

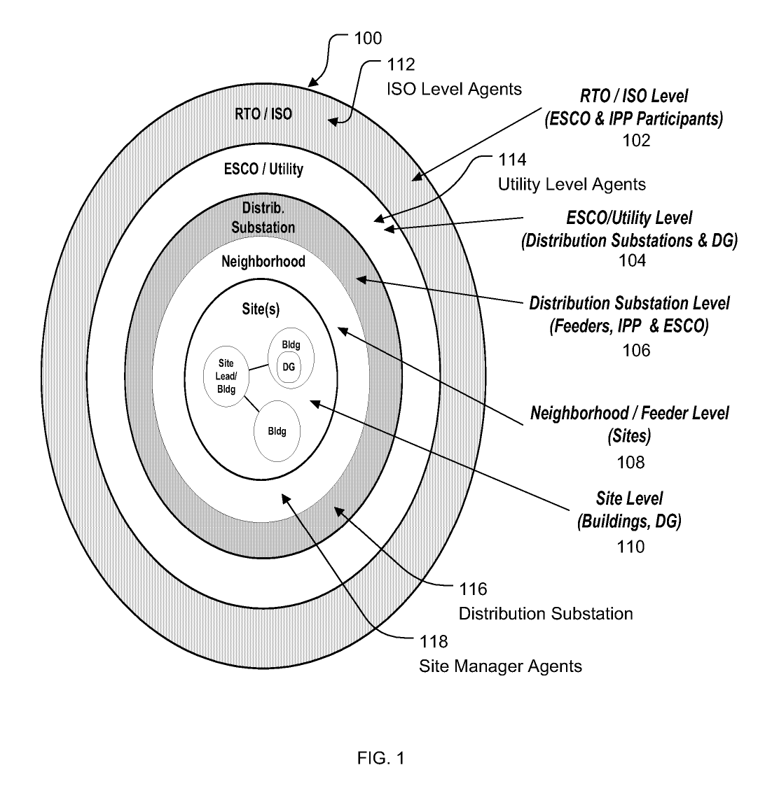

Referring now to the Figures, FIG. 1 is a block diagram illustrating an example hierarchical structure for a power-grid infrastructure according to an embodiment of the present invention. In the illustrated embodiment, the hierarchical structure 100 includes a regional transmission operator (“RTO”)/ISO level 102, an energy services company (“ESCO”)/utility level 104, a distribution substation level 106, a power neighborhood/feeder level 108 and a site level 110. One or more agents reside at each of the levels in the hierarchical structure 100, including one or more ISO level agents 112, one or more utility level agents 114, one or more distribution substation agents 116, and one or more site manager agents 118.

A building agent (not shown) may reside at the site level 110 and may be the lowest level agent capable of decision-making and the ISO level agents 112 representing the RTO/ISO level may be the highest level agents. Additional agents may be used for specific lower level functions within each of the levels but these agents are not required for the basic functioning of the hierarchical structure 100 and are therefore not shown in FIG. 1.

The power neighborhood 108 is the next level in the hierarchical structure 100 above the site level 110. The power neighborhood 108 may include the site manager agents 118. The site manager agents 118 may be considered as a building agent with additional functionality that allows it to represent the interests of multiple building agents within a single site. An individual building has either a building agent or a site manager agent 118.

The power neighborhood 108 is a means to achieve a coordinated response to a command or pricing signal received via the communicative coupling, in a way that distributes the decision-making to the site level. The end result is a portfolio response where the individual site responses are tailored to the needs of the site. This is a dramatic departure from centralized approaches in the prior art that attempt to achieve an aggregated response but concentrate the decision-making for all site actions at a central control level or at a higher level in the hierarchy of the electric grid. The distributed approach used in the power neighborhood concept may be readily expanded to include any number of sites without any change to the basic communication or computing infrastructure. Each site continues to make locally beneficial decisions in response to broadcast signals (i.e., market pricing signals via auction sessions and/or signals indicating that a disruption is eminent, etc.).

The activities of the site manager agents 118 may be divided into local and power neighborhood related activities. Local activities are those activities related directly to the site or to the individual agent. These activities may include PCC management, which includes monitoring of power quality related parameters at the PCC. Problem identification and reporting of abnormal conditions to the distribution substation agents 116 may also be included.

The local activities also may include site load management including monitoring and forecasting of site electric demand. This function may provide the site manager agents 118 with load data for the time period covered by the market of interest.

There are three basic types of site load; critical, curtailable, and normal. Critical load is defined as high priority, high value load such as a manufacturing process or computer load. The site manager agents 118 may typically purchase power, generate power locally and/or curtail other loads as needed to supply critical loads without interruption. Curtailable load is defined as low priority load such as non-critical lighting that may be shut off for economic reasons. Normal load is neither critical nor curtailable and the site manager agents 118 will typically strive to supply these loads with as little interruption as possible.

DER asset management is another local activity of the site manager agents 118, which includes monitoring the asset(s) to evaluate status (availability, output, and performance, etc.), developing operating schedules based on market and local conditions, and implementing the operating schedule. DER assets may or may not always be available. DER assets may include distributed generation (“DG”) or curtailable load assets. The amount of excess capacity (or not) will vary during the day, which will in turn impact the response of the site manager agents 118 to disturbances depending on their time of occurrence.

Situation management is another local activity of the site manager agents 118, which refers to the agent's ability to monitor, assess and act on state information for; 1) the agent itself, 2) the agent's intended goals, 3) other relevant agents in the system, and 4) the system environment. These data may reside in a situation vector for the site manager agents 118. Situation management may also include the ability of the agent to interpret broader goals and objectives (i.e., return on revenue (“ROR”) goal, etc.) along with other user inputs (i.e., fuel costs, critical load, etc.) and system state information and to subsequently identify more specific operating targets such as auction session pricing (i.e., opening prices, reserve prices, target pricing etc.) and near-term goals (i.e., obtain additional capacity via the auction, curtail local loads, etc.).

The situation vector for the site manager agents 118 may contain not only goals and objectives but may also contain a measure of agent “desperation”. Desperation in this case is a relative measure of the agent's ability to succeed in its quest to: 1) obtain sufficient capacity to cover site load, and 2) meet or exceed the overall ROR objectives. The site manager agents may calculate a separate desperation level for each of three load types (normal, critical and curtailable). As a buyer of capacity, the desperation level may increase as the time of delivery (time when capacity is needed) approaches and as the size of the capacity shortfall increases. Thus, the site manager agents 118 may respond to distribution system changes such as loss of supply from the utility level 104 by modifying the situation assessment and the associated targets and/or near-term goals.

Agent performance assessment and modification is another local activity of the site manager agents 118, which refers to the ability of the agent to assess how well it is performing and to subsequently take action to improve performance. One agent performance metric includes whether the agent is achieving the ROR goal. Another performance metric is whether the auction sessions for purchase or sale of capacity is closing early (potentially higher pricing is possible) or with excess capacity (potentially lower pricing is possible). Another performance metric may be whether the agent has delayed a decision to execute a transaction in order to purchase at a lower price. If so, another performance metric is whether the decision to delay has resulted in an improved price or has it resulted in the loss of capacity to another bidder.

Yet another performance metric is based upon what price the agent ultimately paid for the capacity. Another performance metric is whether there have been instances of bid rejections after a decision to transact has been made (loss of bid due to another agent executing first). A bid rejection may be accompanied by a reason (i.e., bid size too small, insufficient capacity remaining, etc.) and these rejection reasons may also be factored into the performance assessment.

The site manager agents 118 may also perform neighborhood related activities. Neighborhood related activities are those activities related to the site manager agents 118 participation in the power neighborhood 108. One neighborhood related activity includes auction status updates. Auction status updates include retrieval of auction session data, for example, from a power neighborhood website maintained by the distribution substation agents 116. An example of the auction session data is shown in Table 1.

TABLE 1

| Item | Description |
|---|---|
| Auctioning Agent ID | Unique identifier for auctioning site manager agent |
| Session ID | Unique auction session identifier to include neighborhood ID |
| Session Type | Generation - sale or purchase, Demand reduction - sale or |
| | purchase |
| Session End Time | Auction session ends at this time. |
| Current Bid Price | Bid price ($/kW) of the offered capacity |
| Bid Modifier | Bid decrement or increment ($/kW) |
| Next Bid Time | Time that bid modifier will be applied to current bid price |
| Available Capacity (kW) | Generation or curtailable load capacity available for purchase |
| Delivery Start Time | Time when the available capacity can be provided. |
| Max Duration (hrs) | Maximum duration in hours that the capacity is available for |
| | purchase. |
| Min Bid Capacity (kW) | Minimum amount of capacity that the seller is willing to |
| | deliver. |
| Min Duration (hrs) | Minimum time period that the seller is willing to provide the |
| | available capacity. |

Periodically, the site manager agents 118 update auction status information: 1) in order to identify new opportunities for the sale or purchase of excess capacity, 2) whenever it receives a signal from the distribution substation agents 116 indicating that auction board connectivity has changed, and 3) whenever the site manager agents 118 have a desperation level that triggers immediate action.

Another neighborhood related activity includes auction analysis. Auction analysis consists of: 1) reviewing existing sessions for opportunities to bid either immediately or in the future, 2) identifying opportunities to post new auction sessions for sale or purchase of capacity, and 3) developing session information for submittal to the auction website.

Another neighborhood related activity includes transaction management. Transaction management may include activities associated with generation or processing of bids associated with existing auction sessions. These activities may include: 1) transaction status update (pending, final, canceled), 2) bid development and transmittal (response to existing session by others), 3) bid negotiation (incoming requests/responses), and 4) transaction execution (recording with the distribution substation agents 116).

The distribution substation agents 116 are typically owned and operated by the ESCO/utility and represents their interests. Distribution substation agent activities can be divided into four basic areas: (1) local coordination of protection and control system; (2) hosting multiple power neighborhood auctions; (3) power neighborhood auction transaction record keeper; and (4) ESCO level auction participation.

The distribution substation agents 116 coordinate operation of the protection and control systems located throughout the distribution system served by its substation as well as communicating substation power quality data to the utility level agents 114 to facilitate ESCO agent coordination of higher level protection and control systems. The distribution substation agents 116 directly control variable tap transformers, sectionalizing breakers and switched capacitor banks, for example, using data provided by the site manager agents 118 to maintain power quality in the various power neighborhoods served by the substation.

In one embodiment, the distribution substation agents 116 monitor, but do not directly control the reclosers, manual switches and fuses. In this way, the existing infrastructure will remain essentially intact. For purposes of example, it is often assumed hereafter that the distribution substation serves two power neighborhoods with a single sectionalizing breaker between them although in reality, the configuration is likely to be more complex.

The distribution substation agents 116 also “host” the power neighborhood auctions. The neighborhood auctions may be conducted based on the Dutch auction process without an active auctioneer. Site manager agents 118, working through the website software may transmit auction session data that are then posted to the website. The website software may then conduct the auction session by automatically updating the asking price per the auction set up directions. It is the responsibility of the individual site manager agents 118 to access the posted auction session data and to submit bids directly to the distribution substation agents 116 hosting the individual auction session of interest.

The distribution substation agents 116 do not host the auction website in the sense that it does not match buyers and sellers nor does the auction data transmitted to the auction website pass through the distribution substation agents 116. The auction website is an independent entity that receives direction from the distribution substation agents 116 related to the electrical and communicative coupling of the various site manager agents 118 that access the auction data. The distribution substation agents 116 define neighborhood boundaries based on feeder connectivity and transmit this information to the website. The website software then may use the boundary data to identify the auction sessions that may be accessed by individual site manager agents 118 within the various neighborhoods. Thus, the distribution substation agents 116 may expand or contract the auction boundaries in response to a grid disturbance.

In the case of a disturbance the distribution substation agent should: (1) Redefine the neighborhood boundaries and transmit this data to the auction website. (2) Identify any temporary auction session restrictions that need to be imposed and transmit this data to the website. For instance, during a disturbance the distribution substation agents 116 may need to impose a time limit on new transactions (between previously unconnected neighborhoods) to facilitate the transition back to normal operation after the disturbance ceases. (3) Broadcast a connectivity change signal to the affected neighborhoods. It is the responsibility of the individual site manager agents 118 to access the website data to determine the implications of the connectivity change.

In addition, as the ESCO representative, the distribution substation agents 116 host auction sessions for sale of ESCO power to the power neighborhoods connected to the substation as well as any auction sessions that involve ESCO owned DG assets connected directly to the substation. In this way, the distribution substation agents 116 take the same action as the site manager agents 118 in that they post auction session information with the website and process incoming bids from site manager agents 118.

The distribution substation agents 116 may also serve as power neighborhood auction transaction record keepers. The distribution substation agents 116, as the representatives of the ESCO, may act as the record keeper for all transactions involving site manager agents 118 located within its power neighborhoods. In this way, the distribution substation agents 116 can more easily identify transactions impacted by connectivity changes within the power neighborhoods as well as provide billing “true-up” services using metering data that are already accessible to the ESCO.

As a transaction record keeper the distribution substation agents 116 should: (1) Maintain a transaction registry for all participants; (2) Monitor distribution system connectivity to confirm overall integrity of transactions and notify site manager agents 118 of invalidated transactions; and (3) Work with site manager agents 118 and the ESCO agents 114 to confirm that transactions were executed (provide “true-up”) properly.

During normal operation the distribution substation agents 116 record and verify transactions. During disturbances the distribution substation agents 116 identify invalidated transactions and notify the affected parties accordingly. Note that this notification of invalidated transactions is specific to individual site manager agents 118. This is different from the previously described signal that the distribution substation agents 116 broadcast to power neighborhoods affected by a connectivity change. Thus, a disturbance may result in site manager agents 118 receiving two messages from the distribution substation agents 116.

The distribution substation agents 116 also provide ESCO level auction participation. Thus, all of the distribution substation agents 116 in an ESCO service territory may participate in distribution level auction(s) coordinated by the ESCO agents 114 and hosted on a separate ESCO auction website, for example. In this case, the ESCO agents 114 define the auction board boundaries based on distribution substation connectivity just as the distribution substation agents 116 defined the boundaries of the power neighborhood auction at the distribution substation level.

The ESCO agents 114, like the distribution substation agents 116 are typically owned and operated by the ESCO/utility. The ESCO agents 114 coordinate protection and control activities as well as coordinate and/or participate in auction related activities. Activities of the ESCO agents 114 may be divided into the following areas: coordination of protection and control systems; hosting ESCO level auctions; participating in power neighborhood auctions; auditing power neighborhood auction transactions; and RTO level auction participation.

Using data, including power quality data, provided by the various distribution substation agents 116, the ESCO agents 114 coordinate operation of the protection and control systems located throughout the distribution systems within its service territory. The ESCO agents 114 may directly control sub-transmission or transmission assets, variable tap transformers and sectionalizing breakers used to control both the power quality and the connectivity between the various distribution substations.

Unlike the power neighborhood auctions coordinated by the distribution substation agents 116, all of the distribution substation agents 116 participating in ESCO level auctions share a common owner, the ESCO. As such, each of the distribution substation agents 116 share the same basic economic goals and objectives. In the case of the power neighborhood auctions, individual sites (site manager agents 118) compete with the traditional suppliers, which may include the ESCO or an independent power provider (“IPP”), to supply their neighbors, or they may compete with their neighbors to purchase capacity. In the ESCO level auction the competition is primarily at the supply side with the ESCO and IPPs competing to supply the needs of the various distribution substations. The ESCO and other suppliers wishing to participate, host auction sessions that the distribution substation agents 116 then bid into based on a pricing criteria tied to the gap between the projected local supply and demand.

The ESCO may then use the resulting auction bid data to determine: (1) whether a need exists for IPP supplied power; (2) the price the ESCO is willing to pay for IPP supplied power; and (3) the composite price of power (ESCO and IPP) supplied to the various distribution substations for use in the lower level power neighborhood auctions. Under this scenario, no transactions between distribution substation agents 116 takes place and the ESCO remains the sole supplier of power to the distribution substations. IPP participation may be via ESCO purchase and resale of IPP energy may be via the power neighborhood auctions.

As with the power neighborhood level auctions, the ESCO may modify auction boundaries in response to grid disturbances and/or other connectivity issues within its service territory. Unlike the power neighborhood auctions the distribution substation agents 116 typically do not compete to supply neighboring substations. Modifying the boundaries in this case would modify the availability of IPP supplied power and potentially modify the composite ESCO/IPP energy pricing. Clearly, there may be a potential conflict of interest in that the ESCO can arbitrarily modify boundaries to exclude the IPP. However, this potential for abuse should be mitigated by the fact that the ESCO acts as a reseller of IPP power and can therefore profit even when the IPP is the supplier.

The ESCO agents 114, via participation in the power neighborhood auctions may aggregate excess DG and/or curtailable load capacity and subsequently bid this capacity into higher level markets such as the auction hosted by the RTO. The existing energy infrastructure also provides for the ESCO agents 114 collecting and processing of metering information for billing purposes. This same infrastructure may therefore be used in conjunction with transaction information provided by the distribution substation agents 116 to provide a monthly transaction “true-up” service for the various distribution substation agents 116 and the power neighborhoods that they represent.

As with the power neighborhood auction, a similar auction may be conducted at the ESCO level and also at the RTO level. Thus, all of the ESCO agents 114 may participate in an RTO level auction coordinated by the RTO and hosted on a separate RTO auction website, for example.

Unlike the ESCO agents 114, the RTO agents 112 may be independent entities that are not driven by profit. The RTO agents 112 may coordinate protection and control activities as well as coordinate and/or participate in auction related activities. Activities of the RTO agents 112 may be divided into the following basic areas: (1) coordination of protection and control systems; (2) hosting RTO level auctions; and (3) RTO auction transaction record keeper and auditing functions.

In one embodiment, the RTO agents 112 may define the RTO level auction board boundaries based on transmission and sub-transmission connectivity (and/or capacity) just as the ESCO agents 114 defined the boundaries of the ESCO level auctions. Note that the RTO level auction is, by necessity, more complex since it incorporates both energy and capacity markets and involves a larger number of competing entities. In addition, the uncertainty of transaction paths becomes more pronounced given the complexity of the networks involved.

In one embodiment, as an independent entity the RTO agents 112 may act as an impartial auctioneer, which would permit the use of more conventional auction processes in addition to the Dutch auction process that occurs for the distribution substation level.

As an impartial entity the RTO agents 112 may act as the record keeper for transactions involving the various entities (ESCO, IPP, etc.) involved in the RTO level auctions. In addition, the RTO agents 112 may provide the true-up service similar to that provided by the ESCO for the distribution level auctions.

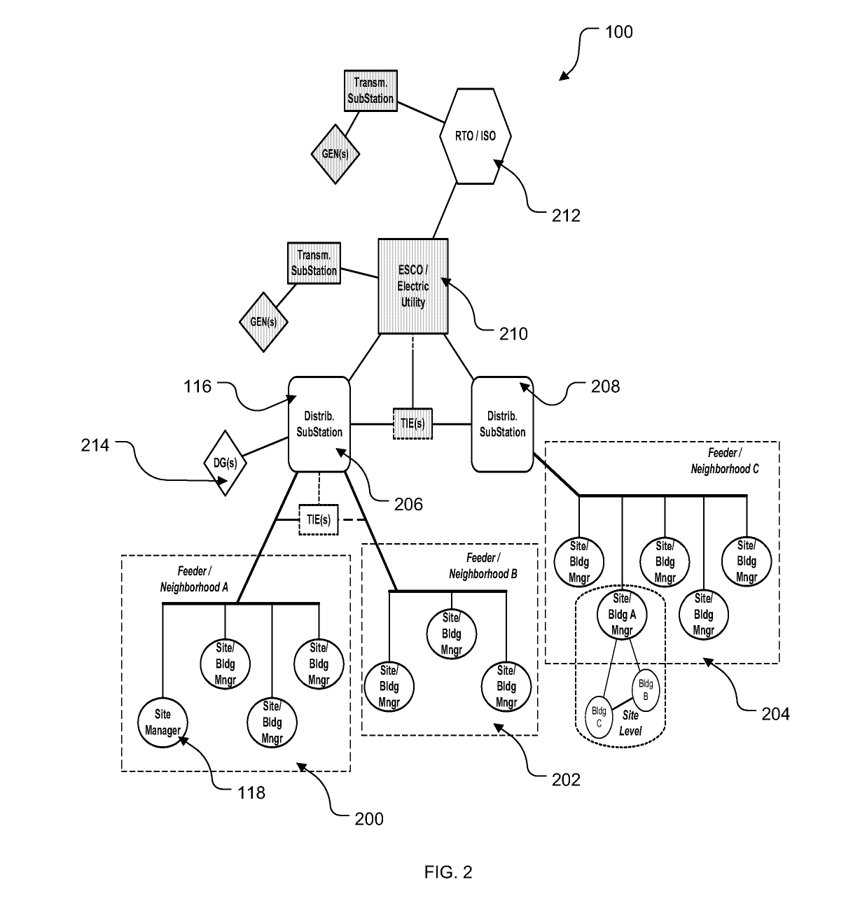

Referring now to FIG. 2, a block diagram illustrating an example electrical coupling according to an embodiment of the present invention is shown. In the illustrated embodiment, the hierarchical structure 100 of FIG. 2 includes a feeder/power neighborhood 200, a feeder/power neighborhood 202, a feeder/power neighborhood 204, distribution substations 206 and 208, an ESCO/utility 210, an RTO 212, distribution substation agents 116, site manager agents 118, and DG assets 214.

Each of the power neighborhoods 200-204 include one or more buildings each represented by a building agent. When multiple buildings are involved, a single building agent may be designated as the site manager agent 118, which represents the interests of the site to external entities. Typically, all building agents within a site have a common owner and are not therefore “conflicted” allowing any of the building agents to represent the others.

Multiple sites located on a common distribution feeder become a “power neighborhood.” Sites within the power neighborhoods 200-204 are able to buy and sell capacity to/from their neighbors and/or they may purchase capacity from the local ESCO 210 or another IPP. Multiple power neighborhoods 200-204 are electrically coupled to and governed by the distribution substation agents 116. The distribution substation agents 116 manage the auction board, which may be Internet based, where neighborhood participants post auction sessions to buy and sell capacity.

The distribution substation agents 116 represent the interests of the ESCO 210 and post auction sessions for the sale of ESCO power into any of the power neighborhoods 200-204, which have an electrical and a communicative coupling. Any of the DG assets 214 electrically coupled directly to the distribution system (not located at a site) capable of supplying power to the neighborhood are represented by their own agent and are able to access the auction board for any neighborhood that has an electrical coupling with the DG assets 214.

Thus, the neighborhood auction process readily accommodates a changing of the electrical coupling between adjacent feeders or power neighborhoods 200-204. The distribution substation agents 116 monitor feeder electrical coupling and contract or expand the auction board area so that affected power neighborhoods 200-204 may access additional or fewer auction sessions. In addition, the distribution substation agents 116 may coordinate the actions of the safety systems within the power neighborhoods 200-204.

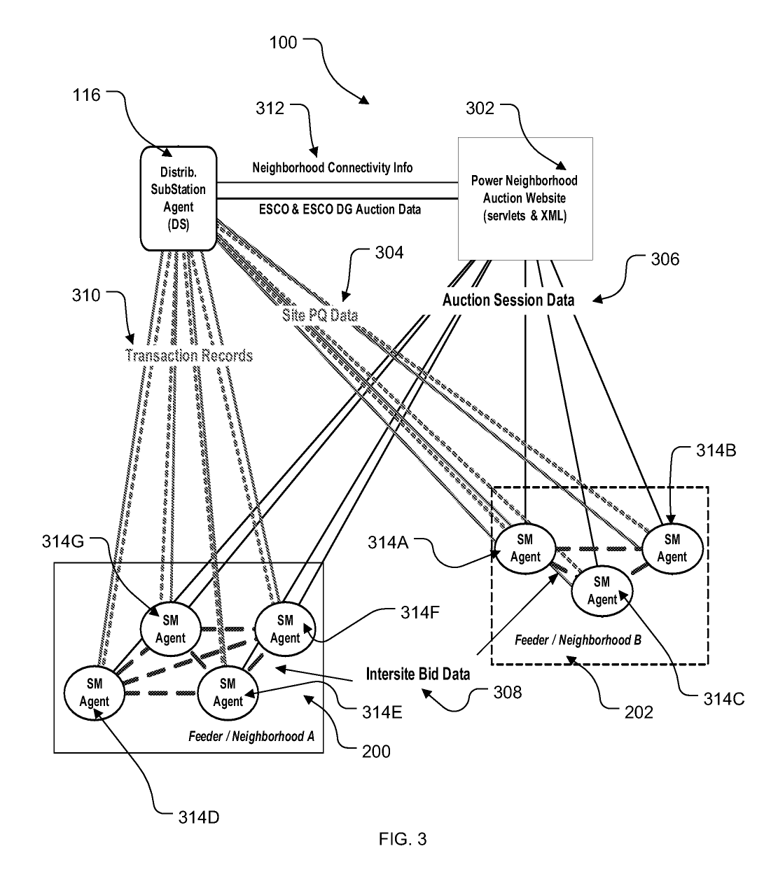

FIG. 3 is a block diagram illustrating an example communicative coupling according to an embodiment of the present invention. In the illustrated embodiment, the communication paths and basic data types involved at this level of the hierarchical structure 100 are shown in more detail. In one embodiment, all communications are Internet based and utilize transmission control protocols/Internet protocols (“TCP/IP protocols.”)

FIG. 3 includes the distribution substation agents 116, the power neighborhoods 200 and 202, site manager agents 314A, 314B, 314C, 314D, 314E, 314F, and 314G, and an auction website 302. The communicative coupling may be based on five basic data types according to one embodiment of the present invention, which include: 1) site power quality data 304, 2) auction session data 306, 3) intersite bid data 308, 4) transaction records 310, and 5) auction board connectivity data 312. The five basic data types may be transmitted via the communicative couplings using a variety of communication media, including radio frequency (“RF”), power line carrier, fiber optic, and the like.

In one embodiment, the site power quality data 304 that is transmitted across the communicative coupling includes, for example, time of day, site total load (kW), site critical load (%), and site curtailable load (%). These data may be communicated between the distribution substation agents 116 and the site manager agents 314A through 314C. This portion of the communicative coupling may be implemented and transmitted, for example, using the knowledge query and manipulation (“KQML”) or foundation for intelligent physical agents (“FIPA”) data protocols.

The auction session data 306 were described previously in Table 1. These data are passed to/from the auction website 302, which may use servlet software, and the site manager agents 314A through 314G, as well as between the auction website 302 and the distribution substation agents 116. In one embodiment, these data are communicated using standard extensible markup language (“XML”) data protocols covering transmittal of data to and from websites.

The intersite bid data 308 may be transmitted between the site manager agents 314A through 314G in response to the auction sessions posted on the auction website 302. These data are described with respect to Table 2 below.

TABLE 2

| Item | Description |
|---|---|
| Bidding Agent ID | Unique identifier for bidding site manager agent. |
| Session ID | Auction session identifier for auction of interest. |
| Current Bid Price | Bid price ($/kW) offered (confirmation of posted data). |
| Requested Capacity (kW) | Maximum amount of generation capacity (positive) or curtailable |
| | load (negative) requested for purchase. |
| Delivery Start Time | Time when the available capacity is requested. |
| Duration (hrs) | Duration in hours that the capacity is requested. |
| Min Bid Capacity (kW) | Minimum capacity that the buyer will accept. |
| Min Duration (hrs) | Minimum time period that the buyer is willing to accept the |
| | available capacity. |

In one embodiment, the data in Table 2 is communicated exclusively between agents and as such is transmitted using the KQML or FIPA data protocols.

The transaction records 310 are intersite bids that have been negotiated and finalized. Therefore the content of these data are analogous to the intersite bid data 308 in Table 2. Transaction records 310 may be transmitted between the site manager agents 314A through 314G and the distribution substation agents 116 and as such may be transmitted using the KQML or FIPA data protocols.

The distribution substation agents 116 determine the connectivity of the various power neighborhoods to determine the auction board connectivity data 312. The auction board connectivity data 312 may be based on the status of the sectionalizing breakers and on the power quality data supplied by the site manager agents 314A through 314G. The distribution substation agents 314A through 314G transmit these data to the auction website 302, which it then uses to modify the “visibility” of the various auction sessions to the site manager agents 314A through 314G.

In one embodiment, these visibility data consist of a list of visible site manager agent ID numbers for each site manager agent 314A through 314G associated with the auction website 302. To reduce the amount of data transmitted, one embodiment allows a power neighborhood ID to be substituted when an entire neighborhood is involved. As with the auction session data 306, the auction board connectivity data 312 may be communicated using standard XML data protocols covering transmittal of data to and from websites. Table 3 provides a description of some of the fields associated with the auction board connectivity data 312 according to one embodiment of the present invention.

TABLE 3

| | Example | |
|---|---|---|
| Example Type | Form | Description |
| Sit manager Agent ID | “A001” | “A” is the power neighborhood ID, “001” is |
| | | the agent number within the |
| | | neighborhood. |
| Power neighborhood ID | “A999” | “A” is the power neighborhood ID, “999” |
| | | indicates that all agents are included. |
| Connectivity String | “A001, A002, | Agent A001 is able to “see” only agents |
| | A003, B999” | A002 and A003 in neighborhood A and all |
| | | agents in neighborhood B. |
| | “A999, B999” | All agents in neighborhood B are visible |
| | | to all agents in neighborhood A. |

At the neighborhood level, one embodiment of the present invention uses a double Dutch auction format at the website auction 302, where site manager agents 314A through 314G (or the distribution substation agent 116 on behalf of the local utility) post auction sessions for either the sale or purchase of capacity on the website auction 302 (managed by the distribution substation agent 116). In one embodiment, the Dutch auction format differs from the traditional “open outcry” also known as the English auction format in that bidding begins high and then declines at a predetermined rate (price decrement and timing). The bid price, decrement value, and decrement timing may be posted as part of the auction session and are therefore known to all bidders.

Under this format, bidders have the option of purchasing all or part of the offered capacity at the stated price or they may wait for the price to decline. However, sellers have the option of withdrawing the item (or the remaining capacity) at any time. Thus, a buyer's decision to delay a purchase to gain a lower price comes with the risk of either losing out to another buyer or the seller may pull the capacity from the auction altogether. Note that the auction process may be inverted for the purchase of capacity. In other words one of the site manager agents 314A through 314G in need of capacity may post an auction session with a low initial bid price that then increases with time. Suppliers can choose to supply all or part of the requested capacity at the stated price or may choose to wait for a higher price (with the same risk factors as before).

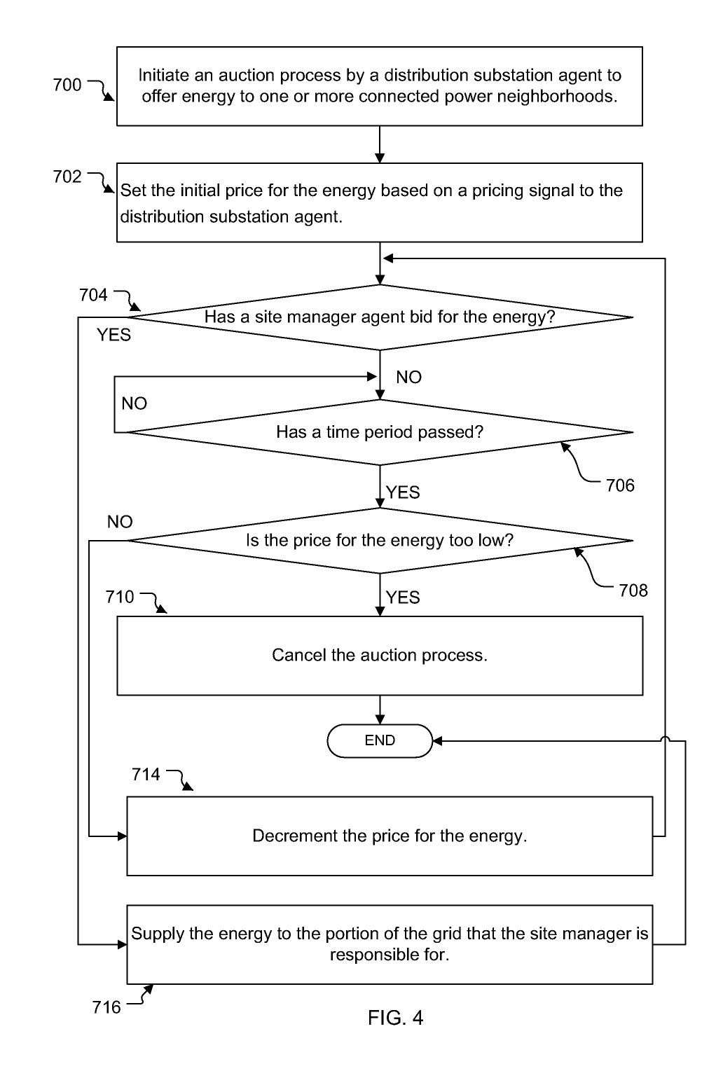

FIG. 4 is a diagram illustrating an example process for conducting an energy auction according to an embodiment of the present invention. This process can be carried out by the distribution substation agent 116 previously described with respect to FIG. 1. At step 700, an auction process is initiated by a distribution substation agent to offer energy to one or more connected power neighborhoods. The auction process may be initiated for example via a website that is available to the site manager agents who may bid for the energy. At step 702, the initial price for the energy is set based on a pricing signal to the distribution substation agent. The pricing signal typically comes from one of the levels in the hierarchy above the distribution substation and may change over time depending on various factors such as supply and demand and other factors that may change the price for energy at any given time.

At step 704 it is determined whether a site manager agent has bid for the energy. If one of the site manager agents did in fact bid for the energy, then at step 716, the energy is supplied to the area of the electric grid that the site manager is responsible for. For example, if there is an electrical coupling between a portion of a power neighborhood that the site manager represents and the distribution substation, then the electrical coupling is used to transfer the energy from the distribution substation level to the power neighborhood level where it is used by buildings and appliances as needed.

If, however, at step 704 none of the site manager agents have bid for the energy (i.e., the intelligence algorithms of the agents cause it not to buy at that price), then the auction host determines if a time period has passed at step 706 in accordance with the rules for a Dutch auction. Step 706 repeats until a sufficient time period has passed, at which time the auction host determines whether the price for the energy has become too low at step 708. If in fact the price has become too low (as determined by the distribution substation agent's own intelligence algorithms and its own self interest), the auction process is canceled at step 710. Therefore, the energy being offered by the distribution substation is not supplied to any of the power neighborhoods who have joined in the auction process.

If, however, the distribution substation agent determines that the price has not become too low, then the price is decremented at step 714 and the process repeats. Thus, the Dutch auction continues in this manner until one of the site manager agents bids for the energy or the price is decremented so far that the distribution substation agent determines that it is in its interest to cancel the auction.

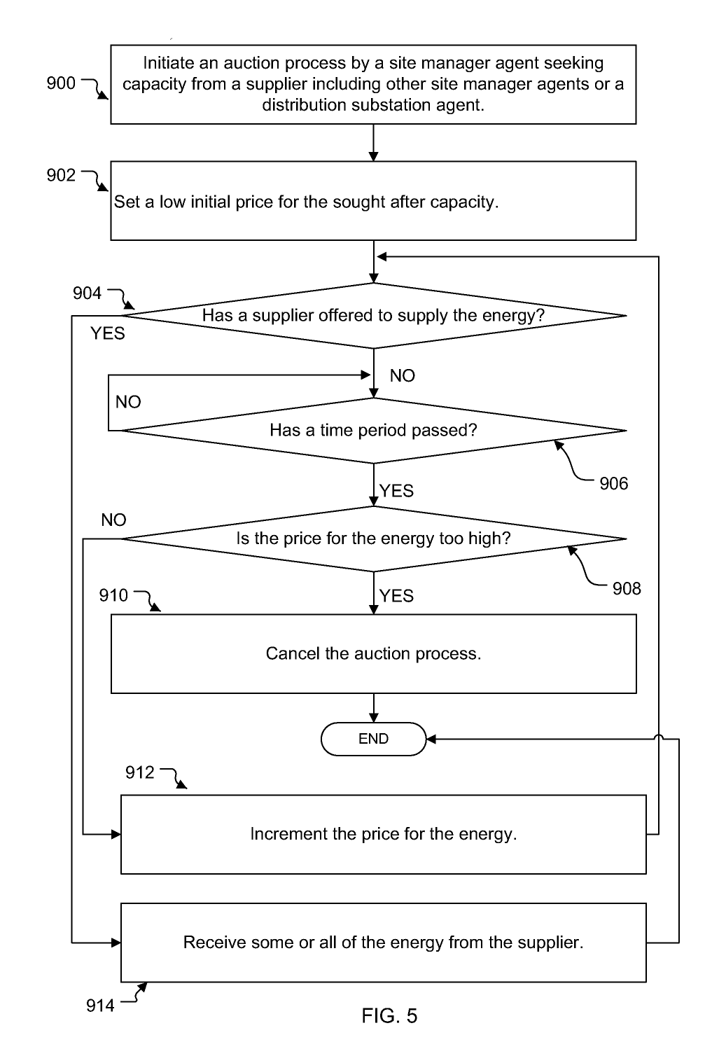

FIG. 5 is a diagram illustrating an example process for conducting an energy auction according to an embodiment of the present invention. This process can be carried out by a site manager agent 118 previously described with respect to FIG. 1. At step 900, an auction process is initiated by a site manager agent seeking capacity from a supplier including other site manager agents or a distribution substation agent. The auction process may be initiated for example via a website that is available to the site manager agents, either intersite or in other power neighborhoods, or by distribution substation agents that are electrically coupled to the initiating site manager agent who may be able to supply the needed energy. At step 902, the initial price for the energy that the site manager is seeking to be supplied is set at a relatively low level, in accordance with the rules for a reverse Dutch auction.

At step 904 it is determined whether a supplier has bid indicating that it is willing to supply some or all of the needed energy at the stated price. If one of the agents did in fact bid to supply the energy, then at step 914, some or all of the energy is supplied the site manager agent who initiated the auction. For example, if there is an electrical coupling between a portion of a power neighborhood that the site manager represents and the supplier, then the electrical coupling is used to transfer the energy from the supplier to the site where it is used by buildings and appliances as needed.

If, however, at step 904 none of the suppliers have bid to supply the energy (i.e., the intelligence algorithms of the agents cause it not to supply the energy at that price), then the auction host determines if a time period has passed at step 906 in accordance with the rules for a reverse Dutch auction. Step 906 repeats until a sufficient time period has passed, at which time the auction host determines whether the price for the energy has become too high at step 908. If in fact the price has become too high (as determined by the site manager agent's own intelligence algorithms and its own self interest), the auction process is canceled at step 910. Therefore, the energy being sought after is not supplied by any of the supplying entities that have joined in the auction process.

If, however, the site manager agent determines that the price has not become too high, then the price is incremented at step 912 and the process repeats. Thus, the reverse Dutch auction continues in this manner until one of the suppliers bid to supply the energy or the price is incremented so far that the site manager agent determines that it is too expensive and in its interest to cancel the auction.

Note that this concept is not limited to generated capacity but may also accommodate demand response or load curtailment. Sites with curtailable loads may create an excess in previously purchased capacity and then sell this excess to neighbors. Or, a site may offer the curtailable load capacity via the auction, which may then be aggregated by the local electric utility and offered in a higher level auction hosted by the RTO/ISO for ancillary services (i.e., spinning reserve, replacement reserve, etc.). Thus the local utility may use the auction process as a means of aggregating curtailable loads.

The auction process therefore provides the site manager agents 118 with the opportunity to participate in the energy markets by: hosting an auction session to sell capacity to a neighbor, the ESCO or another third party aggregator; hosting an auction session to buy capacity from a neighbor, the ESCO or another third party IPP; or participating in one or more auction sessions hosted by other site managers, the ESCO, or a third party IPP.

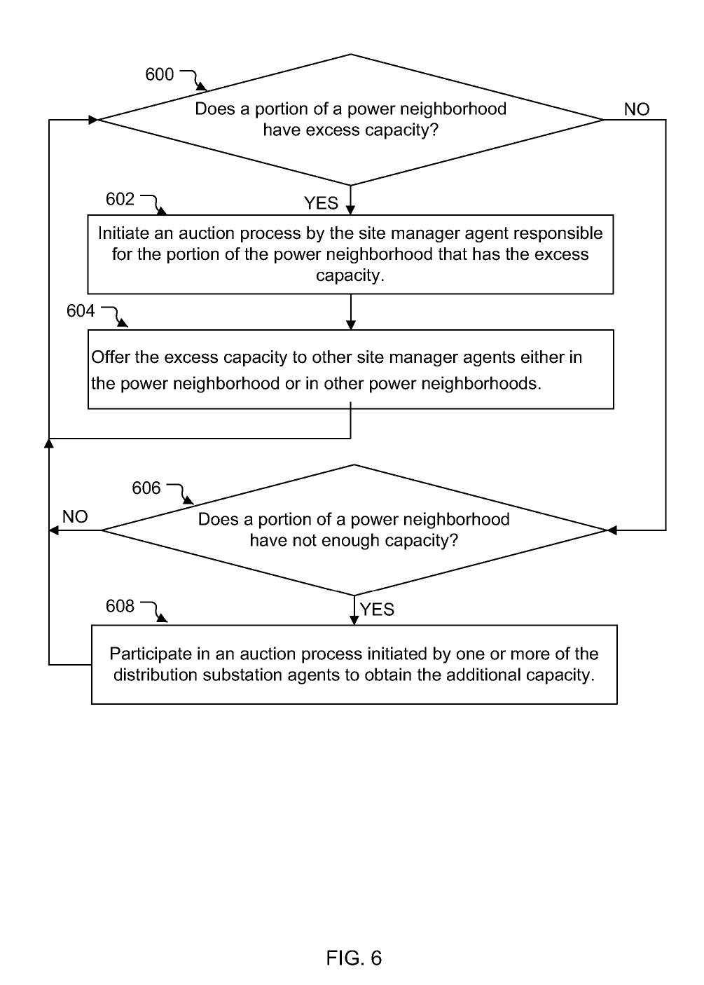

FIG. 6 is a diagram illustrating an example process for agent participation in an auction according to an embodiment of the present invention. This process can be carried out by a site manager agent 118 previously described with respect to FIG. 1. At step 600, it is determined whether a portion of a power neighborhood has excess capacity. For example, if one of the site manager agents determines that one ore more of the buildings that the site manager agent is responsible for has a curtailable load, then at step 602 an auction process is initiated by the site manager agent responsible for the portion of the power neighborhood that has the excess capacity. Therefore in a manner similar to the auction initiated by the distribution substation agent, the site manager agent hosts a website auction module, for example, wherein at step 604 the excess capacity is offered via the auction rules and procedures to other site manager agents either in the power neighborhood or in other power neighborhoods.

After step 604 the process repeats. If the decision at step 600 ever becomes false then it is determined at step 606 whether a portion of a power neighborhood does not have enough capacity. If so, the site manager agent that is responsible for the buildings that need power joins or participates in an auction process that is initiated by one or more of the distribution substation agents to obtain the additional capacity at step 608. After step 608 or if step 606 is false the process repeats as the electric grid changes over time and the various intelligent agents continue to attempt to either supply the capacity to their connected buildings or sell the capacity if some of the buildings have curtailable loads.

The auction process readily accommodates changing connectivity between adjacent feeders or neighborhoods. The distribution substation agents 116 may monitor feeder connectivity and contract or expand the auction board area so that affected neighborhoods may access additional or fewer auction sessions. Thus, this process may be used to facilitate adaptive islanding within the distribution system. It is important to note that the distribution substation agents 116 may use a variety of neighborhood traits to determine when and how to modify the connectivity of the system. The distribution substation agents 116 may therefore utilize neighborhood “fitness” criteria involving such things as the penetration level of DG or curtailable load etc., to determine the appropriate system connectivity.

Auction transactions provide for delivery of various capacity amounts and durations, covering both near- and long-term delivery. Thus an individual one of the site manager agents 118 may contract for long-term delivery of capacity from the ESCO or another IPP (possibly at a discount) and then purchase additional capacity to cover any near-term shortfall (from a neighbor, the ESCO or an IPP). Similarly, one of the site manager agents 118 may choose to secure long-term capacity meeting its maximum needs and then sell excess capacity to its neighbors or back to the ESCO or IPP.

Site manager agents 118 may interact directly to finalize transactions with negotiable terms consisting of capacity amount, delivery start time and duration. Once a transaction is finalized the site manager agents 118 each may register the transaction with one of the distribution substation agents 116 (as auction board facilitator). The site manager agents 118 may also be contractually bound by the “covenants” of the power neighborhood, in one embodiment. These covenants may provide transaction standard terms and conditions, which include provisions for disruption of transactions due to system disturbances as well as provisions covering the consequences of non-performance.

Bid collisions may occur during the auction process. Bid collisions occur when two bidders attempt to negotiate a transaction for the same capacity. In a typical Dutch auction, the auctioneer resolves the collision by increasing the bid price and then allowing the bidders to resubmit their bids, if they so choose. This iterative process may be problematic if it delays the neighborhood response to a system disturbance and this approach gives undue power to the auctioneer. The use of an auctioneer is not therefore part of the power neighborhood concept. There are a number of alternative methods that may be used to resolve bid collisions by various embodiments of the present invention, which include: transactions are handled in the order received regardless of their relative merit; transactions are “graded” based on factors such as the total dollar amount of the transaction, duration of transaction, size of transaction, etc., and then processed based on relative merit; and capacity is distributed amongst competing transactions based on the relative size of the original bids. Thus each bidding party receives an offer for a portion of the original bid amount in proportion to the size of its original bid relative to others.

If the interest in reducing the amount of agent interaction (negotiation of different capacity amounts, etc.) and the associated delay is most important, then the alternative that requires processing of transactions in the order received is typically implemented. This alternative facilitates quicker responses since the auctioning site manager agent may act on bids as soon as they are received rather than accumulating bids and processing them in batches. Using this approach, the auctioning site manager agent negotiates with the first bidder as long as the requested capacity meets the minimum size requirement. Any capacity that remains after the first bid is processed is automatically offered to the next bidder as long as the capacity exceeds the minimum transaction size requirement of both the auctioning and bidding agents. The auctioning agent continues in this fashion until the remaining capacity drops below its minimum transaction size, after which all remaining bids are rejected.

The auction process also may include a means for responding to disruptions and the consequences of a disturbance on existing agreements (executed transactions). According to one embodiment, a disruption in the power grid that prevents the delivery of capacity would cause the distribution substation agent to re-evaluate the connectivity of the feeders to determine if neighborhoods can be temporarily subdivided and/or connected via sectionalizing breakers.

In the case of a disruption, the distribution substation agent may temporarily invalidate agreements that involve the affected sites (all or part of a neighborhood) in one hour increments, for example. Thus, a fault or power outage affecting a neighborhood would cause existing agreements between affected sites for the current hour to be invalidated. The distribution substation agent may identify and notify the affected areas (since all transactions are recorded with the distribution substation agent). As an alternative, the distribution substation agent may notify all connected site manager agents that a “transaction event” has occurred and the individual site manager agents would then need to evaluate the situation as it relates to them.

A disruption might also cause the distribution substation agent to reconfigure the auction board (accessibility of the site manager agents to auction sessions) to allow site manager agents in adjacent neighborhoods additional access. The distribution substation agent then may broadcast a “connectivity event” signal that would cause individual site manager agents to re-evaluate their situation. A disruption might also cause the distribution substation agent to place a duration limit of one hour on all new transactions involving the affected sites, which would force the affected site manager agents to develop new transactions each hour during the disruption.

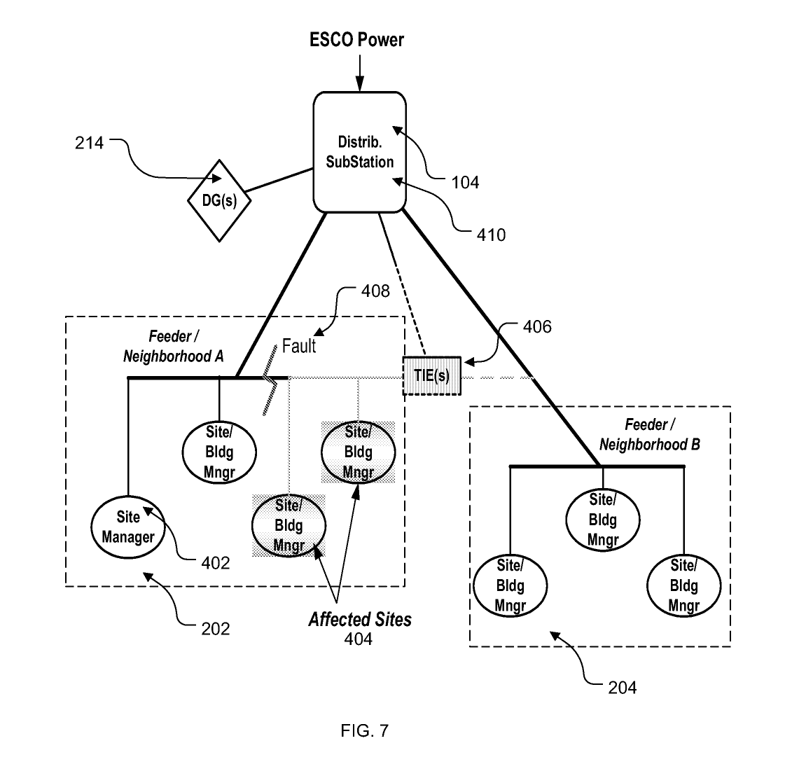

In the case of a disruption, the distribution substation agent should also be able to differentiate between affected and unaffected sites as well as identify affected transactions or agreements. One possible disruption, a fault between adjacent sites in a neighborhood, is depicted with respect to FIG. 7.

FIG. 7 is a block diagram illustrating an example intra-neighborhood transmission disruption according to an embodiment of the present invention. In the illustrated embodiment, FIG. 7 includes a distribution substation 104, a distribution substation agent 410, a DG asset 214, power neighborhoods 202 and 204, a site manager 402, a fault 408, a tie 406, and affected sites 404. In the case of a disruption, the distribution substation agent 410 identifies the potentially impacted sites. In this example those sites are shown as affected sites 404. The tie 506 may be a sectionalized breaker, for example. The distribution substation agent 410 will use the tie 406 to connect the power neighborhoods 202 and 204 and subdivide the power neighborhood 202 to isolate the fault 408.

The distribution substation agent 410 may also temporarily invalidate transactions involving the affected sites 404 in the power neighborhood 202, while keeping transactions involving unaffected sites intact. The distribution substation agent 410 may also recognize that transactions involving the affected sites 404 and the ESCO remain valid since capacity can still be delivered via the electrical coupling to the adjacent neighborhood (assuming that the connection will support the load).

The distribution substation agent 410 may also allow the impacted site manager agents in the power neighborhood 202 access to time constrained (one hour limit) auction sessions posted for the power neighborhood 204. The distribution substation agent 410 may allow site manager agents in the power neighborhood 204 access to auction sessions posted by the impacted site manager agents in the power neighborhood 202 while limiting access by fellow agents in the power neighborhood 202 on the other side of the fault.

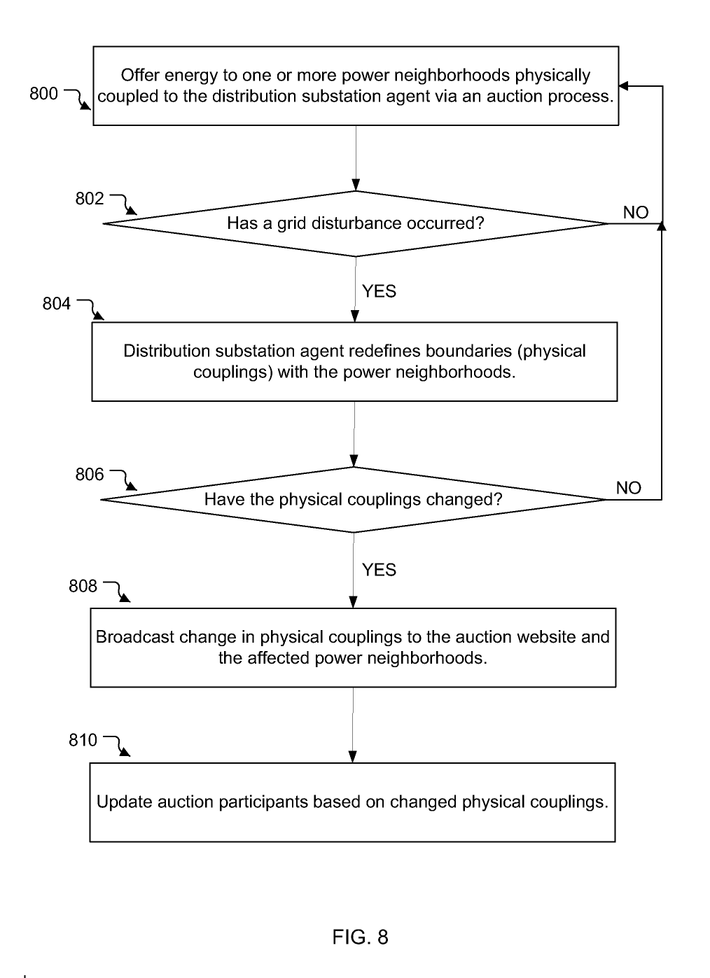

FIG. 8 is a diagram illustrating an example process for handling a grid disturbance according to an embodiment of the present invention. This process can be carried out by a distribution substation agent 116 previously described with respect to FIG. 8. Energy is offered at step 800 to one or more power neighborhoods via an auction process, the power neighborhoods being electrically coupled to the distribution substation agent. At step 802, it is determined whether a grid disturbance occurred? For example, as shown in FIG. 7, the fault 408 may occur as a result of a grid disturbance breaking the electrical coupling between the affected sites 404 and the distribution station 104 for whatever reason, including a mechanical failure, a terrorist attack, a weather outage, etc.

If a grid disturbance has occurred at step 802, the distribution substation agent redefines boundaries (electrical couplings) with the power neighborhoods at step 804. For example, the tie 406 may be controlled by the distribution substation agent 410 so that a change in the route of the energy results from the grid disturbance but all of the sites remain capable of being supplied with power. In that case it is assumed that the electrical couplings have not changed at step 806 and the process repeats.

If at step 806 the electrical couplings do in fact change, then some of the sites are not capable of being supplied with power. This may result, for example, in the absence of the tie 406 in FIG. 7, wherein the affected sites 404 would no longer be electrically coupled to the distribution substation 104. In such a scenario, a change in electrical couplings is broadcast to the auction website and the affected power neighborhoods at step 808. Step 808 may occur for example as a single signal or as several separate signals. In one embodiment, for example, the distribution substation 104 may broadcast a change in the auction boundaries to the auction website. The auction website in turn would notify the individual site. The individual sites via their site manager agents would then develop the appropriate response. Therefore, at step 810 the auction and its participants is changed based on the changed electrical couplings.

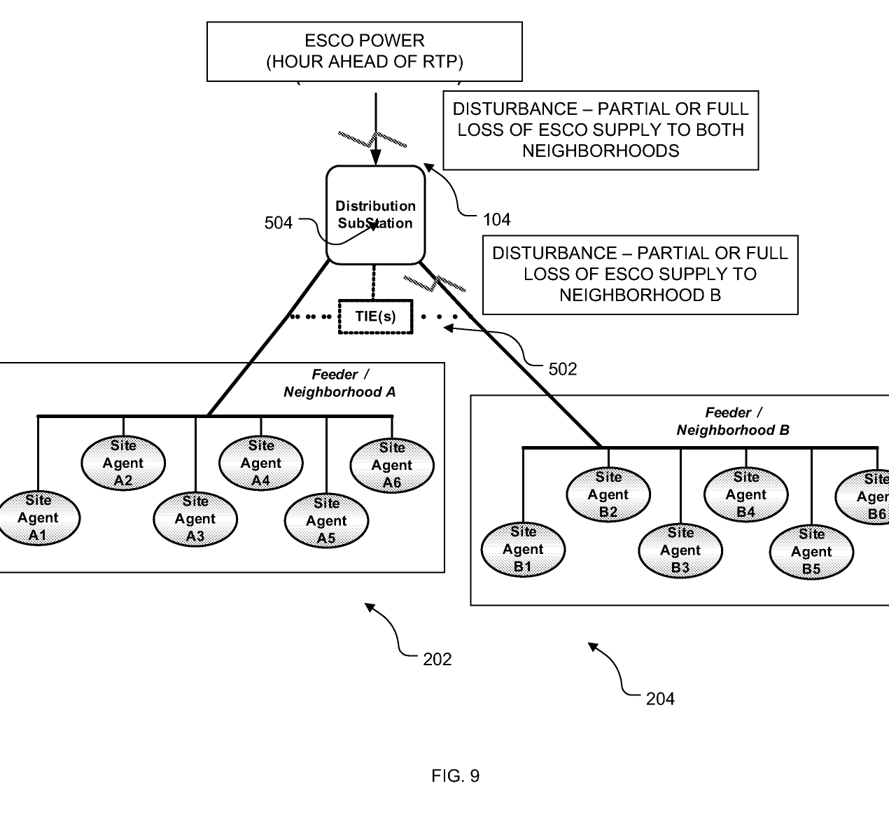

Another disruption example according to an embodiment of the present invention, loss of ESCO power to the distribution substation, is depicted in FIG. 9. FIG. 9 includes a distribution substation 104, a distribution substation agent 504, power neighborhoods 202 and 204, and a tie 502. In the case of a disruption, the distribution substation agent 510 should identify the potentially impacted sites as all of the sites in the power neighborhoods 202 and 204. The distribution substation agent 510 should then alter the electrical couplings so that the power neighborhoods 202 and 204 are connected using the tie 502, which may be a sectionalized breaker.

The distribution substation agent 510 should also temporarily invalidate transactions involving the affected sites and the ESCO while keeping intra-site transactions intact within each neighborhood as well as transactions involving the DG units, if any, connected to the distribution substation 504. The distribution substation agent 510 should also allow the impacted site manager agents in power neighborhood 202 access to time constrained (one hour limit) auction sessions posted for the power neighborhood 204 and vice versa.

It should be noted that an additional connection to another distribution substation could be initiated at the ESCO level, which would potentially provide additional auction connectivity. It is also important to note that there are issues related to operation of distribution system protective devices and issues related to connecting and disconnecting to and from the power grid that are also be addressed, as is further defined below.

In one embodiment, the distribution substation agent is responsible for operation of the protection and control systems. There are typically five protection and control system devices of greatest applicability: variable tap transformers, switched capacitor banks, sectionalizing switches, network protection breakers, and fuse reclosers. In general, the distribution substation agent actively controls regulation type devices in order to mitigate the disruptive effect of DG operation while leaving safety related devices intact. These devices are described briefly in the following subsections.

The Variable Tap Transformer (“VTT”) provides voltage regulation at the distribution level. The tap point of the transformer may be varied, in steps, to modify the transformer output voltage. Typically, a remote voltage sensing point downstream of the VTT is used to regulate the VTT output. A VTT may be remotely controlled or may operate stand-alone. The problem arises when a DG unit operates between the VTT and the remote voltage sensing point causing the VTT to incorrectly modify its tap settings. This could pose a problem in the proposed auction environment since export of on-site DG capacity locally into the power grid could adversely impact voltage regulation. Therefore, the distribution substation agent should provide active VTT control in the power neighborhoods to mitigate these affects. The distribution substation agent typically has local power quality information (i.e., voltage, frequency, etc.) as provided by the individual site manager agents to facilitate control of the VTT.

Capacitor banks located strategically throughout the distribution system are used to compensate for variations in site reactive power requirements. Thus a large industrial site with large motor loads would have a capacitor bank nearby to counter the large inductive loads experienced during motor operation. As with VTT operation, DG unit operation and/or sudden curtailment of large motor loads in the vicinity could disrupt operation of these capacitor banks and degrade the power quality in the area. Therefore, the distribution substation agent actively controls the switched capacitor banks to mitigate the impact of auction operations on local power quality.

Sectionalizing switches are used to connect or disconnect feeders within the distribution system. These switches may be manually or remotely operated and may be normally open or closed. These switches typically remain in one position or another unless a system fault requires a temporary reconfiguration of the distribution system. Distribution substation agent operation of these switches is therefore a requirement of the proposed auction based system since it gives the distribution substation agent the ability to reconfigure the neighborhoods in response to system disturbances.

Network protection breakers and fuses limit the delivered power to acceptable levels. These safety devices trip automatically and are typically reset or replaced manually. These devices provide the most basic level of protection and as such, operation of these systems will remain unchanged under the proposed auction-based system. However, the distribution substation agent should be able to ascertain the status of these devices based on the power quality data coming from the site manager agents in order to correctly reconfigure the neighborhoods (i.e., in response to a local fault, etc.).

Reclosers are protection devices that open the involved circuit in response to a system fault (over current) and then automatically attempt to close after a fixed period of time. If the over current persists then the recloser will open again. This process will continue for a preset number of cycles after which the recloser will remain in the open position. As with the network protection breakers and fuses, the recloser provides a basic level of protection and will not therefore be actively controlled by the distribution substation agent. Instead the distribution substation agent should be able to interpret the power quality exception data provided by the site manager agents to ascertain that a recloser event is occurring.

Electric Grid

In order to characterize the world as seen by a DER level agent it is instructive to review electric grid operation and the problems and issues that are unique to this highly complex and vital infrastructure. Operation of the electric grid can be characterized as having three basic modes, normal, disturbance and restorative, each with varying operational requirements. Operation of the electric grid is far more than scheduling and coordinating the transfer of power from point A to point B since it requires on-going control of power quality (voltage, frequency, etc.). In general, varying the generation (and import/export of power at interconnection points) at various points in the grid indirectly controls the flow of power at the transmission and subtransmission levels. FACTS (“flexible alternating current transmission systems”) technology can provide dynamic control and compensation within the grid. However, use of these devices can actually increase the size and speed of catastrophic events unless dynamic control systems with compatible analysis, decision and communications are utilized.

Since its beginnings over 100 years ago the North American power grid has evolved into an expansive and highly complex network. The power grid is comprised of half a million miles of transmission lines connecting over 10,200 power plants that supply 274 million Americans and 31 million Canadians. There are three basic operating levels for delivery of power: 1) transmission, 2) subtransmission, and 3) distribution.

The transmission system consists of transmission lines and associated transmission substations that operate at either extra-high voltage (>300 kW) or high voltage (100 kV-300 kV) levels. The transmission system is used to connect large central generating stations and some large customers as well as to transfer power between neighboring transmission or subtransmission networks. Transmission system networks are highly interconnected meshed networks.

The transmission system is organized into separate but interconnected control areas each typically under the control of either an ISO or an RTO. ISOs and RTOs control their respective transmission systems in accordance with the guidelines of the North American Electric Reliability Council. Control is exercised from a central location using automated monitoring and control (“SCADA”) systems. Coordination of power transfers between the various control areas is accomplished via direct communication (telephone) between system operators.

Subtransmission networks connect medium sized generators, supply regional power needs and some large customers. These networks are radial or weakly coupled networks that typically operate in the 5 kV-300 kV voltage range. The subtransmission system may be controlled by the control area ISO/RTO or may be controlled by the local electric utility company.

Distribution systems are typically low (110 V-240 V) or medium (1-100 kV) voltage tree networked systems connected to small generators, medium customers and local networks for small customers. Distribution system control is handled by the local electric utility. Control automation can vary significantly depending on the age and location of the equipment. Supervisory control and data acquisition (“SCADA”) systems may be used to remotely control distribution system equipment or control may be initiated manually.

The distribution grid typically consists of substations, primary feeders, laterals, primary (high) voltage/secondary (low voltage) distribution circuits and associated switching, monitoring and protection circuitry. Normal power flow is from the bulk power source at subtransmission voltage levels of 12.47 kV to 245 kV to the distribution substations. The substations have power transformers and ancillary control equipment to send power along the primary feeders at voltage levels ranging from 4.16 kV to 34.5 kV. These feeders distribute power to customer sites and step down the voltage to 480 V/240 V/208 V/120 V as required by the site. To improve reliability the distribution substations may be configured in a grid or network.

While distribution systems are diverse in their layout they share some essential components needed for protection, monitoring and control. The typical distribution system has a coordinated system of overcurrent (fault) protection devices. The idea is for the protection device closest to the fault to activate as fast as possible to isolate the fault from the rest of the system. Additionally, there are protective layers that extend from high current lines (closest to the substation) to the minimum current lines (farthest from the substation).

A properly coordinated protection scheme should trip a device at a lower current line and allow adjacent or parallel lines to operate. For example, if there were a fault downstream from one of the three limiters shown, the appropriate limiter would open without affecting the network protector fuse or the network protector breaker. If a fault occurs such that the network protector opens, ideal coordination would prevent the station breaker from also opening. It is important to note that “coordination” in this case refers to interaction of manual trip setpoints, which are preset based on historical and projected distribution system load levels.

In addition to protection devices that act based on over current conditions, distribution systems usually also have a SCADA system. This system allows for supervision and possibly control of a network. A SCADA system is comprised of remote monitoring units that measure voltage, current, VAR, switch status and other parameters. There are also remote devices that allow switch operation to connect/disconnect tie lines, capacitor banks or sectionalizers. The data are sent to a central location where operators can observe system operation. If circuit changes need to be made based on scheduled maintenance, or emergency conditions, the SCADA operator can modify the distribution system by adding or removing circuits, isolating feeders or take other action depending on the level of automation that is available. SCADA system manufacturers use various communication protocols that include COMLI (“communication link”), ModBus (an industry standard communications protocol developed by Modicon Inc. that works with most SCADA systems), DNP 3.0 (“distributed network protocol”) and TCP/IP.

It is important to remember that operation of the electric grid is far more than scheduling and coordinating the transfer of power from point A to point B. Ultimately, operation of the grid requires on-going control of power quality (voltage, frequency, etc.) throughout the grid at any given time. Add to this, the fact that electricity cannot be stored in appreciable amounts and you have a complex, dynamic operational environment where the laws of science ultimately control the flow of power, not commercial schedules or contracts.

This complexity is apparent when one examines the time scale of various operations and actions within the electric grid. This diversity is illustrated in Table 4, which shows a table of the time scale hierarchy of power systems. As the table shows, the time scale varies from the micro-millisecond range (lighting induced surges, overvoltage switching, etc.) to seconds (stability control, load/frequency control, etc.) to hours/days (economic dispatch, load forecasting, etc.) or longer.

TABLE 4

| Action/Operation | Time Frame |
|---|---|
| Wave effects (fast dynamics, | Microseconds to milliseconds |
| lightning caused overvoltages) | |
| Switching overvoltages | Milliseconds |
| Fault protection | 100 Milliseconds or a few cycles |
| Electromagnetic effects in machine | Milliseconds to seconds |
| windings | |
| Stability | 60 cycles or 1 second |
| Stability Augmentation | Seconds |
| Electromechanical effects of oscillations | Milliseconds to minutes |
| in motors and generators | |
| Tie line load frequency control | 1 to 10 seconds; ongoing |
| Economic load dispatch | 10 seconds to 1 hour; ongoing |
| Thermodynamic changes from boiler | Seconds to hours |
| control action (slow dynamics) | |
| System structure monitoring (what is | Steady state; ongoing |
| energized and what is not) | |
| System state measurement and | Steady state; ongoing |
| estimation | |
| System security monitoring | Steady state; ongoing |
| Load management, load forecasting, | 1 hour to 1 day or longer; |
| generation scheduling | ongoing |
| Maintenance scheduling | Months to 1 year; ongoing |
| Expansion planning | Years; ongoing |
| Power plant site selection, design, | 10 years or longer |
| construction, environmental | |
| impact, etc. | |

Operation of the electric grid can be further characterized as having three basic modes: normal operation, disturbance and restorative. Activities that must routinely occur during normal grid operation include economic dispatch (generation, load, transmission, etc.), load frequency control, maintenance, forecasting, etc. Disturbance activities are activities directly related to the occurrence of, and immediate response to faults and instability, etc. (sectionalizing switches, reclosers, etc.) Restorative activities are activities associated with system recovery from a disturbance (rescheduling, resynchronization, load restoration, etc.).

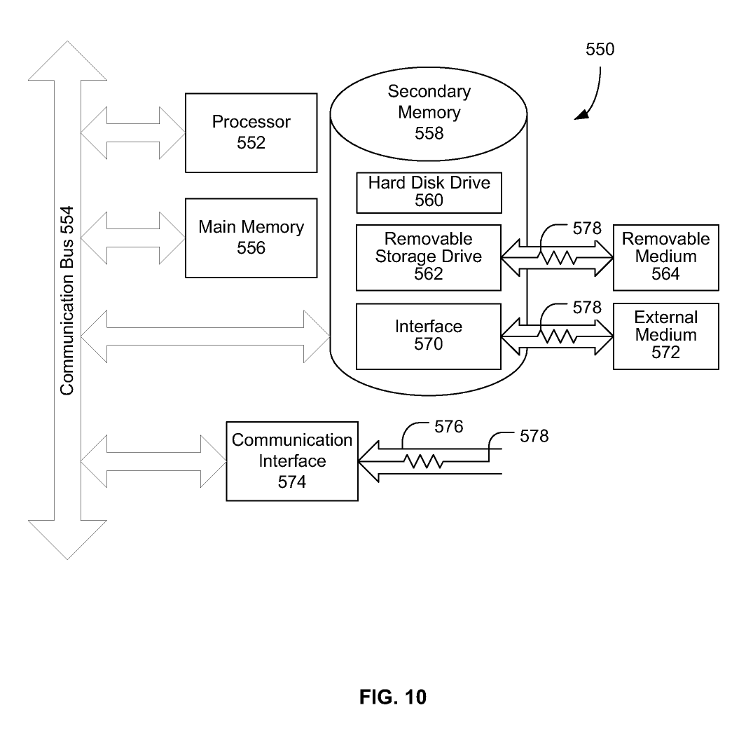

FIG. 10 is a block diagram illustrating an example computer system 550 that may be used in connection with various embodiments described herein. For example, the computer system 550 may be used in conjunction with any of the levels in the hierarchical structure 100 of FIG. 1, including the RTO/ISO level 102, the ESCO/utility level 104, the distribution substation level 106, the power neighborhood/feeder level 108 and the site level 110. The agents that reside at each of the levels in the hierarchical structure 100 may also be software, hardware, or firmware modules, for example, which may be implemented in conjunction with the computer system 550. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. An energy distribution system comprising:
one or more independent system operator (“ISO”) stations, each of the ISO stations including an ISO station agent and having a communicative coupling and an electrical coupling to at least one of the utility stations;
one or more utility stations, each of the utility stations including a utility station agent and having a communicative coupling and an electrical coupling to at least one of the distribution substations;
one or more distribution substations, each of the distribution substations including a distribution substation agent and having a communicative coupling and an electrical coupling to at least one of the power neighborhoods;
one or more power neighborhoods, each of the power neighborhoods including a plurality of site manager agents communicatively coupled and electrically coupled together;
an auction module configured to facilitate the distribution of energy, including an ISO station auction that includes one or more of the utility station agents as participants, a utility station auction that includes one or more of the distribution substation agents as participants, and a distribution substation auction that include one or more of the power neighborhoods with site manager agents as participants;
a first command signal from a distribution substation agent, a utility station agent, or an ISO station agent, wherein a behavior of a site manager agent is modified based on the command signal; and
a second command signal from a site manager agent, wherein a behavior of a distribution substation agent, a utility station agents, an ISO station agents, or a second site manager agent is modified based on the second command signal.

2. The system of claim 1 wherein the second command signal indicates an amount of load within a power neighborhood where one or more of the site manager agents is included, and wherein the behavior of one or more of the site manager agents is modified by using the auction module to purchase or to sell energy based on the amount of load indicated in the second command signal.

3. The system of claim 1 wherein the first command signal indicates information about the auction module and wherein the behavior of the site manager agents are modified by altering a behavior associated with bidding in the auction module based on the information about the auction module.

4. The system of claim 1 wherein the first command signal includes a pricing signal and wherein the behavior of the site manager agents is modified by using the auction module to purchase or to sell energy based on the pricing signal.

5. The system of claim 1 wherein the distribution substation agent modifies the auction module in response to a change in the electrical coupling between the site manager agents.

6. The system of claim 1 wherein the distribution substation agent modifies the electrical coupling between the site manager agents in response to the second command signal from one of the site manager agents that one of the electrical couplings is disrupted.

7. The system of claim 1 wherein the distribution substation agent modifies one or more parameters of the auction module based upon the availability of the energy between the utility stations and the power neighborhoods.

8. The system of claim 1 wherein the distribution substation agent stores information associated with the auction module relating to any transactions that occur from the site manager agents that are in any of the power neighborhoods having an electrical coupling to the distribution substation.

9. The system of claim 1 wherein the distribution substation auction includes a Dutch auction comprising, a price for the future delivery of energy wherein the price is reduced over a time period, until one or more of the site manager agents bids for the energy.

10. The system of claim 1 wherein the distribution substation auction includes a Dutch auction comprising, a price for the future purchase of energy wherein the price is increased over a time period until one of the distribution substation agents, site manager agents, ISO station agents, or utility station agents bids to supply the energy.

11. The system of claim 1 wherein the energy is supplied from one or more of a turbine or a microturbine, an internal combustion generator, a battery, a fuel cell, a wind turbine, a solar generators, or a combined heat and power package.

12. The system of claim 2 wherein the amount of load within the power neighborhood is determined by data from one or more of a motor, boiler, pump, compressor, elevator, chiller, or lighting.

13. The system of claim 1 wherein the second command signal indicates an amount of excess capacity within a region of a first power neighborhood associated with a first site manager agent, further comprising:
initiating the auction module by the first site manager agent; and
offering the excess capacity to other site manager agents either in the first power neighborhood or in other power neighborhoods.

14. The system of claim 1 wherein the distribution substation auction includes a Dutch auction comprising, a price for the energy wherein the price is reduced over a time period, further comprising an auction session host withdrawing the availability of the energy before any of the site manager agents bids for the energy.

15. The system of claim 1 wherein the distribution substation auction includes a Dutch auction comprising, a price for the energy wherein the price is increased over a time period, further comprising an auction session host withdrawing the availability of the energy purchase before any of the site manager agents bids to supply the energy.

16. The system of claim 1 wherein the second command signal indicates an amount of deficient capacity within a region of a first power neighborhood associated with a first site manager agent, further comprising:
initiating the auction module by the first site manager agent; and
offering to purchase the excess capacity of other site manager agents either in the first power neighborhood or in other power neighborhoods.

17. A method for distributing energy within an energy infrastructure including at least one or more power neighborhoods, each of the power neighborhoods including a plurality of site manager agents communicatively coupled and electrically coupled together and one or more distribution substations, each of the distribution substations including a distribution substation agent and being communicatively coupled and electrically coupled to at least one of the power neighborhoods within its control area, the method comprising:
broadcasting a signal for an auction process by a distribution substation agent;
joining the auction process by one or more of the site manager agents as participants upon receipt of the broadcasted signal;
offering a price for the sale or purchase of energy;
determining whether the energy was bid upon by the participating site manager agents;
determining if a time period has passed;
modifying the price for the energy if the time period has passed and the energy was not bid upon by any of the participating site manager agents;
determining if the price for the energy is less than a minimum threshold or exceeds a maximum threshold; and
withdrawing the offered energy if the price for the energy falls below the minimum threshold or exceeds the maximum threshold.

18. A method for distributing energy comprising:
providing an energy infrastructure including, one or more power neighborhoods, each of the power neighborhoods including a plurality of site manager agents communicatively coupled and electrically coupled together, one or more distribution substations, each of the distribution substations including a distribution substation agent and being communicatively coupled and electrically coupled to at least one of the power neighborhoods, one or more utility stations, each of the utility stations including a utility station agent and being communicatively coupled and electrically coupled to at least one of the distribution substations, one or more independent system operator (“ISO”) stations, each of the ISO stations including an ISO station agent and being communicatively coupled and electrically coupled to at least one of the utility stations;
distributing energy via a first auction process, wherein the first auction process includes an ISO station auction that may include one or more of the utility station agents as participants;
distributing energy via a second auction process, wherein the second auction process includes a utility station auction that may include one or more of the distribution substation agents as participants; and
distributing energy via a third auction process, wherein the third auction process includes and a distribution substation auction that may include one or more power neighborhoods with the site manager agents as participants.

19. The method of claim 18 further comprising:
sending a command signal from one of the site manager agents indicating an amount of load within a power neighborhood where the site manager agent is included; and
using the third auction process to purchase or to sell energy based on the amount of load indicated in the command signal.

20. The method of claim 18 further comprising:
sending a command signal from one of the distribution substation agents to one or more of the power neighborhoods, wherein the command signal indicates information about the third auction process; and
altering a behavior associated with bidding in the third auction process based on the information about the third auction process.

21. The method of claim 18 further comprising:
sending a pricing signal from one of the distribution substation agents to one pr more of the power neighborhoods; and
using the third auction process to purchase or to sell energy based on the pricing signal.

22. The method of claim 18 further comprising:
sending a command signal from one of the site manager agents to one of the distribution substation agents indicating information about a change in the electrical couplings within a power neighborhood; and
modifying the third auction process in response to the command signal.

23. The method of claim 18, further comprising:
receiving a signal at one of the distribution substations from one of the site manager agents indicating that a portion of the electrical coupling is disrupted; and
modifying the electrical coupling between the site manager agents by one of the distribution substation agents in response.

24. The method of claim 18, further comprising:
determining the availability of the energy between the utility stations and the power neighborhoods; and
modifying one or more parameters of the third auction process based upon the step of determining.

25. The method of claim 18, further comprising, storing information associated with the third auction process relating to any transactions that occur from the site manager agents that are in any of the power neighborhoods having the electrical coupling to the distribution substation.

26. The method of claim 18 wherein the step of providing an auction process further comprises:
providing a Dutch auction in the distribution substation auction, including a price for the energy; and
modifying the price for the energy over a time period, until one or more of the site manager agents bids for the energy.

27. The method of claim 18 wherein the step of distributing energy via a third auction process further comprises:
offering the energy at a specified price; and
withdrawing the availability of the energy before any of the site manager agents bids for the energy.

28. The method of claim 18, further comprising, supplying the energy from one or more of a turbine or a microturbine, an internal combustion generator, a battery, a fuel cell, a wind turbine, a solar generators, or a combined heat and power package.

29. The method of claim 19 wherein the amount of load within the power neighborhood includes data from one or more of a motor, boiler, pump, compressor, elevator, chiller, or lighting.

30. The method of claim 18 further comprising:
sending a signal indicating an amount of excess capacity within a region of a first power neighborhood associated with a first site manager agent;
initiating the third auction process by the first site manager agent; and
offering the excess capacity to other site manager agents either in the first power neighborhood or in other power neighborhoods.

31. The method of claim 18 wherein the step of distributing energy via a third auction process further comprises:
offering the energy at a specified price;
determining if a time period has passed;
changing the specified price for the energy if the time period has passed.

32. The method of claim 31 wherein the step of changing the specified price for the energy if the time period has passed further comprises reducing the specified price for the energy.

33. The method of claim 31 wherein the step of changing the specified price for the energy if the time period has passed further comprises increasing the specified price for the energy.
